(19) United States
(12) Patent Application Publication
(10) Pub. No.: US 2013/0243839 A1
(43) Pub. Date: Sep. 19, 2013

(54) Controlled, Sustained Release Particles for Treating Seeds and Plants and Methods for Making the Particles

(71) Applicants: David D. Taft, Menlo Park, CA (US); Damian Hajduk, San Jose, CA (US); Natarajan Balachander, West Lafayette, IN (US); Xinhua Zong, San Jose, CA (US); Qiang Zheng, Palo Alto, CA (US)

(72) Inventors: David D. Taft, Menlo Park, CA (US); Damian Hajduk, San Jose, CA (US); Natarajan Balachander, West Lafayette, IN (US); Xinhua Zong, San Jose, CA (US); Qiang Zheng, Palo Alto, CA (US)

(73) Assignee: Landec Corporation, Menlo Park, CA (US)

(21) Appl. No.: 13/570,165

(22) Filed: Aug. 8, 2012

Related U.S. Application Data
(60) Provisional application No. 61/521,307, filed on Aug. 8, 2011.

(51) Int. Cl. A01N 25/26

(52) U.S. Cl. CPC A01N 25/26
USPC 424/418; 514/341; 424/419

(57) ABSTRACT

The invention relates to active particles, including core-shell particles, having low burst, controllable, sustained release which are useful for coating seeds. The active particles can also be used in sprayable and dry formulations for treating soil or plants. The particulate coating can also contain inert organic or inorganic material. The invention also relates to methods for preparing the active particles. The methods include: adding additional material to core particles to form a shell, removing active ingredient from a core surface to create an active-depleted shell, and crosslinking the outer layers of a core to form a shell.

### CROSS-REFERENCE TO RELATED APPLICATIONS

This application is related to U.S. Provisional Patent Application No. 61/521,307, filed on Aug. 8, 2011, entitled “Controlled, Sustained Release Particles for Treating Seeds and Plants and Methods for Making the Particles”, the entire contents of which are incorporated herein by this reference. The Applicants hereby claim the benefits of these earlier pending provisional applications under 35 U.S.C. Section 119(e).

### BACKGROUND OF THE INVENTION

The invention relates to active particles, including core-shell particles, for low burst, sustained release of an active ingredient and methods for making the particles.

Seeds are often treated with materials to protect the seed, for example with fungicides, pesticides, and other materials to facilitate the flowability and plantability of the seed through common seed planters. Early polymer seed coatings often comprised water soluble polymers, such as polyacrylic acid, and were typically highly filled with fillers to prevent hygroscopic side effects. Highly filled coating formulations, however, are not very flexible and often crack upon impact, resulting in dusting. Importantly, seed treatments must be flexible, impact resistant and adhere well to the seed to prevent dusting during packing, storage and planting of the seeds.

In addition to the beneficial physical properties of flowability, plantability, low dust-off, and low bridging (sticking between seeds), it is advantageous to control the rate and duration of release of the active ingredient. In core-shell controlled release systems an inner core of active ingredient is encapsulated with a hard outer impermeable shell. Many encapsulated systems have been developed in the chemical industry but most suffer either from inadequate encapsulation or from burst, i.e., premature rupture of the shell and release of the encapsulated products due to collisions between the particles. Because the encapsulated product is often a highly filled, water soluble polymer, albeit with some film former formation, upon moisture exposure, water enters through the filler and water soluble polymer, causing swelling and diffusion of the actives out of the encapsulated product. Moreover, the process for encapsulation is often a multi-step elaborate process which involves mixing the polymer and fillers to build a series of layers and requires encapsulated product isolation, filtration, etc. that again leads to premature release of the encapsulated product.

Upon burst of an encapsulated system, the active ingredient is released at a high initial rate, often exceeding the desired therapeutic level or application rate, and then declines rapidly in release, resulting in a less than desired sustained release of the active ingredient over a long period of time at the desired effective rate. As a result of the early release of the active ingredient, and subsequent decay and runoff, the active ingredient may not be available when needed, for example, when pest infestation occurs.

The use of sprayable formulations and dry, granulated or powdered formulations is common in commercial and vegetable crop production to control fungi, weeds and pests and increase yield during the early and mature growth of crop materials. Sprayable and dry formulations include, but are not limited to, fertilizers, pesticides, biological treatments, and micronutrients. Sprayable and dry formulations can be applied onto: the soil into which seeds have been planted, seedlings, plant leaves, emerged seedlings, and growing plants or injected into the soil. After application of these treatments, however, unexpected rain or storms often wash off the active ingredients, reducing their efficacy and increasing the undesirable environmental side effects of runoff into lakes and streams.

The ability to deliver the active ingredient with low burst and controlled, sustained release has highly beneficial properties. For example, lower phytotoxic effects are observed with low burst formulations. Lower phytotoxic effects can result in more robust seedlings, better stand count or number of seedling emerging once planted, and higher germination rates, ultimately leading to higher yields. In addition, sustained release with low burst enables effective delivery of active ingredient over a long period. Extending the period of active ingredient present at effective levels decreases the necessity of having to apply additional sprayable or powdered treatments, such as, fungicides, insecticides or other pesticides, after planting. Fewer applications of treatments after planting results in reduced costs. Controlled, sustained release sprayable and dry formulations may also reduce the amount of runoff of active ingredient.

Thus, there is a need for compositions which deliver an active ingredient with low burst and controllable, sustained release and methods for making the compositions.

### SUMMARY

The present invention satisfies these needs with active particles comprising an active ingredient in a polymer matrix which delivers the active ingredient with low burst and controllable, sustained release. The invention also provides methods for making the active particles.

In a first aspect, the active particles are suitable for use in coating seeds, including, but not limited to: soybean, sugarbeet, sunflower, alfalfa, sorghum, rapeseed and tobacco.

In a second aspect, the active particles are added to a sprayable or dry formulation. The dry formulation may be granulated or powdered. The sprayable and dry formulations can be applied onto: the soil into which seeds have been planted, seedlings, plant leaves, emerged seedlings, and growing plants or injected into the soil.

A third aspect describes methods of making the active particles using additive, subtractive, and cross-linking approaches.

In one embodiment, the seed coating consists of: (a) about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone, and polysaccharide, (b) about 0.005 to about 50% by weight of an insecticidally effective amount of an insecticide selected from the group consisting of terbufos, chlorpyrifos, fipronil, chlorethoxyfos, tefluthrin, carbofuran, imidacloprid, tebupirimfos, methoprene and hydroprene, and (c) about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof, and optionally water. In one embodiment, the binder is a vinyl acetate-ethylene copolymer or polymer or copolymer of vinylidene chloride.

In another embodiment, the seed coating is an insecticidal coating consisting of a binder in an amount from about 0.01 to about 15% of the weight of the seed wherein said binder is a vinyl acetate-ethylene copolymer or polymer or copolymer of vinylidene chloride and an insecticidally effective amount of an insecticide selected from the group consisting of imidicloprid, chlorpyrifos, fipronil, tefluthrin and tebupirimfos and in the range from about 0.005 to about 50% of the weight of the seed, and about 0.01% to about 20% by weight of a film overcoat selected from the group consisting of methyl cellulose, hydroxypropylmethylcellulose, polyvinyl acetate and polethylene glycol.

In yet another embodiment, the seed coating is an insecticidal coating consisting of: (a) about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone and polysaccharide, (b) about 0.005 to about 50% by weight of an insecticidally effective amount of an insecticide selected from the group consisting of terbufos, chlorpyrifos, fipronil, chlorethoxyfos, tefluthrin, carbofuran, imidacloprid, tebupirimfos, methoprene and hydroprene, and (c) about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof, and optionally, one or more of water, one or more fungicides or herbicides, or both, a filler selected from the group consisting of woodflours, clays, inorganic solids, activated carbon, diatomaceous earth and calcium carbonate, and mixtures thereof, a plasticizer, a bird repellent compound, a safener, a fertilizer, a biocontrol agent, a colorant, a brightener, a surface active agent and a seed primer.

The invention encompasses seeds coated with the coatings described herein.

The invention also encompasses methods for controlling insect pests and protecting emerging seedlings from insect organisms comprising applying a coating described herein to a seed.

In an embodiment, the method for making a core-shell particle suitable for coating a seed comprises: (a) mixing an active ingredient with a crystalline polymer to form an active associated with a polymer matrix, (b) suspending the active associated polymer in a solution of coating material, (c) changing the chemical characteristics of the solution of step (b) to precipitate the coating material onto the active associated polymer to form core-shell active particles, and (d) filtering the solution to recover the core-shell active particles.

In another embodiment, the method for making a core-shell active particle suitable for coating a seed comprises: (a) suspending active particles in a solvent, wherein the solvent dissolves the active in the outer layers of the active particle, and wherein the polymer matrix is not dissolved, and (b) filtering the suspension to recover the partially dissolved core-shell active particles.

In yet another embodiment, the method for making a core-shell active particle suitable for coating a seed comprises: (a) mixing about 0.005 to about 50% by weight of an active ingredient selected from the group consisting of pesticides, fungicides, herbicides, namaticides, insectides, fertilizers, plant growth regulators, and micronutrients with about 0 to about 40%, preferably about 0 to about 30%, by weight of particulate material selected from the group consisting of a clay, a treated clay, a silica powder, an attapulgite material, finely ground natural cellulosic materials, and regular or modified starches to allow the active to penetrate the surface of the particulate material, (b) adding about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone, and polysaccharide; (c) mixing the active, particulate material, and binder above the melting point of the binder; (d) cooling the active, particulate material, and binder mixture to form a solid, (e) grinding the mixture into a fine particulate active particle, and (f) mixing the active particle with about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof.

The invention also encompasses making a cross-linked active particle suitable for coating a seed comprising: (a) mixing an active particle suspended in an aqueous solution with a cross-linking additive, and optionally a catalyst, and (b) filtering to recover the cross-linked active particle.

### DETAILED DESCRIPTION

In describing and claiming the invention below, the following abbreviations, definitions, and methods of measurement (in addition to those already given) are used.

The terms “active(s),” “active ingredient(s)” and “active material” are used interchangeably herein to mean a material that destroys or inhibits the growth of an organism. “Active particle” means at least an active associated with a polymer and may include additional material.

The terms “association”, “associated” and the like mean any type of interaction, including chemical bonds (including, for example, covalent, ionic and hydrogen bonds) and/or Van der Waals forces, and/or polar and non-polar interaction through other physical constraints provided by molecular structure, and interactions through physical mixing.

“Controlled” release of an active ingredient means release of the active ingredient in a pre-determined or adjustable way such that the amount or rate or timing of release is pre-set or is altered in a desired way.

“Sustained” release of an active ingredient means release over an extended period of time, for example minutes, hours or days, such that less than all the active ingredient is released initially.

Parts, ratios and percentages are by weight, except where otherwise noted. Molecular weights of polymers are in Daltons, are number average molecular weights (Mn) unless stated to be weight average molecular weights (Mw), and are measured by gel permeation chromatography (GPC) with a light scattering detection method, using a DAWN DSP laser photometer from Wyatt Technology. “Melting point” (often abbreviated Tm or Tp) is determined using a differential scanning calorimeter (hereinafter DSC), e.g. a Q 100 DSC from TA Instruments.

As used in this specification, the singular forms “a, an”, and “the” include plural reference unless the context clearly dictates otherwise. Thus, for example, a reference to “a part” includes a plurality of such parts, and so forth. For example, a composition which comprises a side-chain crystalline (“SCC”) polymer and a drug can comprise two or more SCC polymers and/or two or more drugs.

The term “comprises” and grammatical equivalents thereof are used in this specification to mean that, in addition to the features specifically identified, other features are optionally present. For example, a composition “comprising” (or “which comprises”) ingredients A, B and C can contain only ingredients A, B and C, or can contain not only ingredients A, B and C but also one or more other ingredients. The term “consisting essentially of” and grammatical equivalents thereof is used herein to mean that, in addition to the features specifically identified, other features may be present which do not materially alter the claimed invention. The term “at least” followed by a number is used herein to denote the start of a range beginning with that number (which may be a range having an upper limit or no upper limit, depending on the variable being defined). For example “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

Where reference is made in this specification to a method comprising two or more defined steps, the defined steps can be carried out in any order or simultaneously (except where the context excludes that possibility), and the method can optionally include one or more other steps which are carried out before any of the defined steps, between two of the defined steps, or after all the defined steps (except where the context excludes that possibility).

When, in this specification, a range is given as “(a first number) to (a second number)” or “(a first number)-(a second number)”, this means a range whose lower limit is the first number and whose upper limit is the second number. For example, “from 40 to 70 microns” or “40-70 microns” means a range whose lower limit is 40 microns, and whose upper limit is 70 microns.

This specification incorporates by reference all documents referred to herein and all documents filed concurrently with this specification or filed previously in connection with this application, including but not limited to such documents which are open to public inspection with this specification.

In one embodiment, the active particles consist of a core and a shell. The core may consist of only active ingredient, or may contain active ingredient dissolved or dispersed in a core matrix. The shell may contain no active ingredient or may contain active ingredient dissolved or dispersed in a shell matrix. The core and shell matrices may be identical.

Active ingredients include, but are not limited to, pesticides, fungicides, herbicides, nematicides, insecticides, fertilizers, plant growth regulators, and micronutrients, etc.

Examples of suitable pesticides are disclosed in U.S. Pat. No. 5,849,320, which is incorporated herein in its entirety.

Examples of suitable fungicides include fungicides selected from the group consisting of propiconazole, azoxystrobin, triadimefon, trifloxystrobins, derivatives thereof, and mixtures thereof.

A fertilizer may be a fully formulated fertilizer mixture containing nitrogen, phosphorus and potassium components or a fertilizer of one of any of the normal fertilizer components of nitrogen, of potassium (potash, for example), of phosphorous containing components and possible additives and coating materials used in fertilizer mixtures, for example, urea-formaldehyde resins, sulfur, polyurethanes and the like.

In one embodiment, the starting particles consist of active ingredient dispersed in a polymer matrix. A preferred polymer matrix is comprised of a side-chain crystalline polymer as described in other Landec patents or applications describing controlled and sustained release using side chain crystalline and end capped crystalline polymers, including: U.S. Pat. Nos. 6,989,417; 7101,928; 6,199,318; 6,831,116; WO/2009073192; US 2008/0269105, which are incorporated herein by reference in their entirety. In one aspect, the polymer is a polymer or copolymer comprised of long chain acrylates or methacrylates and optionally comonomers containing polar groups, with a molecular weight from about 1,000 to about 1 million, preferably about 2,000 to about 100,000 and more preferably about 4,000 to about 50,000, which when mixed with an active above the melting point of the polymer, forms a matrix which, when cooled below the melting point, can be ground into a small particle size material. In one aspect, the core-shell structure may be achieved by starting with the particles comprising the core and adding additional material to form a shell enclosing the core (additive approach). In another aspect, the core-shell structure may be achieved by starting with the particles comprising the core and removing active from the surface and outer layers of the particle to create an active-depleted shell (subtractive approach). In a third aspect, the outer layers of the core are cross-linked to form the shell (crosslinking approach).

In the additive approach, the particles are suspended in a solution of coating material and the chemical characteristics of the solution are changed to cause the coating material to precipitate onto the particles. The particles may consist solely of the active ingredient, or may comprise active ingredient dispersed or dissolved in a polymer matrix. Precipitation may be induced by: diluting the solution with a non-solvent, adding the particle suspension to an excess of non-solvent, adding an acid or base to change the pH of the solution, adding or removing an electrolyte from the solution, changing the temperature of the solution, or another suitable technique. In a preferred embodiment, the coating material is a wax. Alternate coating materials include fatty alcohols, fatty acids, or suspensions of water-dispersible polymers, silicones, etc.

Alternatively, a wax solution or emulsion may be intimately mixed in a pan coater, for example, with particles comprising an active dispersed in a polymer matrix. The mixture is then fluidized and the solvent (for solutions) or carrier (for emulsions) is removed in a pipe-loop, for example. The dry particles are combined with a carrier, typically a liquid or paste formulation, for ease of handling and easy mixing later. This embodiment, unlike the additive approach described above, does not use thermodynamic driving force for the emulsion to preferentially coat the particles as the carrier is removed.

In an embodiment, a wax emulsion may be intimately mixed with a ground active-crystalline polymer matrix in a mixer, such as a rotary mixer, such as a rotostat mistamatic mixer or pan coater and then fluidized to remove the aqueous carrier in a pipe-loop before diluting these particles in a second mixing step with a formulation or paste carrier for ease of handling and easy mixing later of the coated particles with other formulation ingredients or a completed formulation prior to seed coating or application as a sprayable soil or foliar treatment.

Wax emulsions which are cationic or anionic may be used as a change in pH or ionic strength may cause desirable precipitation of the wax material on the surface of the particles. In an embodiment, a cationic or anionic treated porous material, such as small amounts of a silica material or bentonite clay may be admixed as a portion of the active and side chain crystalline polymer matrix. These ion active sites can then act as attraction sites for precipitation of an ion active wax treatment. For example, a cationic emulsified wax may be used as a treatment for a particle containing an anionic clay admixed into the active and side chain crystalline polymer matrix. The presence of these porous and inorganic particle materials as part of an active ingredient and polymer matrix may be beneficial as these porous materials can provide additional sites for loading of one or more active ingredients or a formulation of active ingredient(s) and the crystalline polymers.

In an embodiment of this invention, any active ingredient may be admixed with a high surface area particulate material, including but not limited to, a clay, a treated clay, for example, a hydrophobic bentonite clay or fatty nitrogen treated bentonite clay, a silica powder, for example, a hydrophobic silica, for example, Aerosil R-972, an attapulgite material, colloidal hydrated magnesium alumino-silicates like Attagel attapulgites, offered by BASF, finely ground natural cellulosic materials like ground corncobs, walnut shells, and regular or modified (cationic or anionic or nonionic) starches with the crystalline polymer materials of this invention and then melted to provide a molten mixture (by mixing in batch, in a Z-blade mixer, or an extruder) and then cooled by spraying, by casting as a flat sheet continuously and by cooling in bulk. The material is then ground mechanically into the desired active ingredient and polymer particles. A suitable amount for this optional ingredient would be up to about 40%, more preferably, from about 0 to about 5%, from about 0 to about 10%, from about 0 to about 15%, from about 0 to about 20%, from about 0 to about 25%, or from about 0 to about 30% or any range of percentages therebetween (e.g., from about 10% to about 30%, from about 25% to about 30%, etc.), depending on the desired properties and for this ingredient, about 0 is an amount less than 1% to and including 0%.

In an embodiment, the composition comprises a ternary mixture of active ingredient, crystalline polymers and inorganic particulate or organic particulate materials, whereby the active ingredient is first mixed with the inorganic and/or organic material to allow the active ingredient to penetrate across the surface of the inert organic or inorganic material. Treated clays, starches, etc. that are anionic, cationic or nonionic may associate with the active ingredient, allowing stronger attractions to occur between the active ingredient and the inorganic or organic particulate material. Once these materials are mixed the crystalline polymer is introduced preferentially at about 100% solids as a solid granulated material or a molten material above the melting point of the crystalline polymer. The three materials are mixed in a batch or continuously in an extruder above the melting point for a period of time and then cooled to form a solid which can be ground into a ternary mixture of active ingredient, crystalline polymer, and inorganic and/or organic particulate material. Preferably, the active particles have a particle size of about 150 microns or less, more preferably about 100 microns or less, even more preferably about 80 microns or less. Preferably, the active particles have a particle size of about 10 microns or more. Most preferably, the active particles have a particle size of about 40 to about 70 microns. Particle size as used herein can be measured by methods known in the art, including laser scattering particle size analysis, light obscuration based analysis, etc. The polymer, inert particle and active ingredient composition is then applied as part of the seed treatment, sprayable formulation or dry granule and/or powder mixture.

In the subtractive approach, the particles are suspended in a solvent that dissolves the active in the outer layers of the particle without dissolving the polymer matrix. The duration of exposure is selected to remove sufficient active from the outer layers of the particle so as to reduce or eliminate burst.

In another embodiment, the spinning disk technology developed by Southwest Research Institute is used to make the active particles of the invention. This process is described in U.S. Pat. Nos. 7,261,529 and 7,758,778, for example, both of which are incorporated herein by reference in their entirety. In this process, a solution of a polymer and active material is mixed in a solvent in order to get a low viscosity solution suitable for application to a rapidly spinning disk. The rapid spinning forces the polymer active combination to roll off the disk, forming a microparticle with a polymer rich shell and an active rich core as the solvent evaporates from the polymer-active combination. In a preferred embodiment, the polymer is a side chain crystalline polymer. Side chain crystalline polymers are particularly attractive for use in the spinning disk process because these polymers can be low in molecular weight and can form a crystalline solid at a relatively low temperature. Because the side chain crystalline polymers have sharp melting points (independent of molecular weight), the active and polymer mixture can be combined into a relatively low viscosity mixture/matrix at temperatures above the melting point of the polymer. The molten polymer/active blend can be above or below the melting point of the active. As a result, spherical and low particle size particles may be obtained by the spinning disk method without having to use a solvent. Thus, the spinning disk method enables encapsulation of difficult to solubilize active ingredients or of active ingredients where any residual solvents might be harmful as in the application as a drug or as a seed coating. Also, the absence of solvent requirement reduces cost and eliminates solvent recovery during processing. These encapsulated active particles have a lower burst than a randomly prepared active polymer matrix which is ground in that the outer crystalline wall reduces the release rate of active.

As part of the active polymer matrix, either a cationic or anionic treated porous material, such as small amounts of a silica material or bentonite clay may be admixed as a portion of the active and side chain crystalline polymer matrix. Then, these ion active sites can act as attraction sites for precipitation of an ion active wax treatment. For example, a cationic emulsified wax may be used as a treatment for a particle containing an anionic clay admixed into the active and side chain crystalline polymer matrix.

Similarly the formulation of the active and side chain crystalline polymer may contain a low surface contact angle material such as a siloxane material either as a comonomer part of the side chain crystalline copolymer or as an additive. A low contact angle corresponds to more hydrophilic material. After being formed by grinding, the particles may then be treated with a small amount of an emulsified polysiloxane polymer that can be crosslinked to the reactive siloxane monomer in the initial polymer/active matrix or a small amount of a predispersed silicone oil.

In the crosslinking approach, the polymer matrix contains reactive functionalities. In an embodiment, the particles are suspended in a non-solvent, and a material is added that reacts with these functionalities to crosslink the polymer matrix on the outer surface of the particle. The material may include a catalyst to promote the crosslinking reaction. Examples of suitable functionalities include hydroxyl groups, for which the corresponding reactive materials include simple diisocyanates. The reactive materials can be applied to the preformed matrix particles after grinding to the appropriate particle size. Alternatively, additives can be admixed into an aqueous formulation containing the suspended particles. The hydrophobic nature of these reactive additives drives them to the hydrophobic surface of the particles. Either a reactive polyol additive in the matrix particles or a copolymerized comonomer in the side chain crystalline polymer, for example, hydroxyethyl acrylate or the like, is available to react with the crosslinking additives. Examples of additives to apply include simple diisocyanates like metaphenylene diisocyanate (polyphenylene diisocyanate—“PAPI”), toluene diisocyanate (“TDI”), tetramethylxylene diisocyanate (TMXDI), or hexamethylene diisocyanate (“HDI”) or its active biuret (Desmodur N as supplied by Bayer). Other active crosslinking additives include a trialkoxy-silanepropylisocyanate, or other trimethoxy- or triethoxy- end terminated siloxanes. In an alternate embodiment, the reactive functionality is an acrylate, and the reactive material is a reducing agent plus a catalyst.

To effect particle surface crosslinking in-situ in the formulation carrying the active-side chain crystalline particles, multifunctional acrylate monomers are added to the formulation together with small amounts of catalyst and reducing agent (formopon and either benzoyl peroxide or dilauroyl peroxide).

The additive approach may be combined with the crosslinking approach. In this embodiment, the polymer matrix of the particles contain reactive functionalities, and the particles are combined with a solution, emulsion, or suspension of a material that is then crosslinked to the surface of the particle using one of the chemical approaches described above. Suitable materials for crosslinking include emulsions of silicone oils or siloxane polymers.

In all of these examples, a reactive additive is additive, optionally with a catalyst, to promote reaction of the additive with functional groups on the surface of the particle. The highly crosslinked surface acts as a barrier to prevent aqueous entry and dissociation of actives from the side chain crystalline polymer and active matrix particle.

### EXAMPLES

### Preparation of Active Microparticles

A seed treatment formulation is prepared by combining Maxim4FS (0.64 g, fl.oz./cwt), Allegiance (0.574 g, fl.oz/cwt) and microparticle (364-143) (2.23 g of a 30% loading of imidacloprid) together with CF clear polymer (0.072 g, fl. oz/cwt), CC Colorcoat Red (0.63 g) and water (3.325 g). The mixture is vortexed for 30 seconds to get a complete dispersion of the microparticles in the coating formulation. The coating formulation is then applied to 1 kg of soybean seed on a rotostat coater by a process described below. The seeds are then dried under ambient conditions.

In a second example the polymer CF clear is replaced by Intellicoat ST-1000 (0.574 g, fl. oz/cwt) and additional water is adjusted to 0.9 g to give a total slurry volume of the formulation of 9.0 fl.oz/cwt. The coating is applied as described in the application process described below.

In a third example, the microparticles are replaced by Gaucho 600 insecticide (1.283 g, fl. oz/cwt) and applied to the seed using either of the procedures described above. These samples are used as controls in evaluation of microparticles described in this invention.

### Application of Microparticles to Seed

The soybean seed treatments are applied on an ETS R-12 rotostat treater. Soybeans are loaded in the treater and the formulation solutions described above are added to the atomizing disc spinning at a high rate. The cycle time for application is 8 sec after which the seeds are automatically discharged from the coater and dried at ambient temperatures.

### Preparation of Wax-Coated Particles

Matrices were suspended in 5 ml of a 50:50 (vol. %) isopropanol: water mixed solvent containing 1 wt% C14 wax. The suspension was then immediately added dropwise to 50 ml of water over approximately three minutes and filtered to recover the coated particles. After drying, the particles were dispersed in a seed coating formulation and applied to soybeans. Control coatings were prepared in a similar manner with particles that were not coated with C14 wax. After further drying, the coated soybeans were suspended in water, and aliquots were periodically withdrawn and analyzed to determine the quantity of active released from both sets of coatings. Coatings containing wax-coated particles showed significant reductions in the amount of active initially released compared to coatings containing untreated particles.

### Preparation of Particles Using Subtraction Approach

Four hundred (400) mg of particles were suspended in 5 ml of a 50:50 (vol. %) isopropanol:water mixed solvent for ten minutes. The suspension was then filtered to recover the partially extracted particles. After drying, the particles were dispersed in a seed coating formulation and applied to soybeans. Control coatings were prepared in a similar manner with particles that were not subjected to the extraction procedure. After further drying, the coated soybeans were suspended in water, and aliquots were periodically withdrawn and analyzed to determine the quantity of active released from both sets of coatings. Coatings containing partially extracted particles showed significant reductions in the amount of active initially released compared to coatings containing untreated particles. Analysis of the amount of active present in the particles before and after partial extraction indicated that the extraction procedure removed an amount of active equal to the amount released from untreated particles in the first few hours of release.

### Preparation of Particles Using Crosslinking Approach

To prepare crosslinked particles, 500 mg of particles consisting of active dispersed in a polymer and 2.5, 12.5 and 25 mg of TMXDI were weighed in three 20 ml vials. Particles in each vial were suspended in 10 ml of water containing a saturated concentration of the same active. One to three drops of triethylamine solution (0.1 gram TEA in 0.9 gram IMI saturated water) was added into each vial, respectively, and allowed to react by rolling the vials at room temperature overnight. Each suspension was filtered to recover the coated particles. After drying, all particles, along with the untreated particle, were dispersed in a seed coating formulation and applied to soybeans. The coated soybeans were suspended in water for release test, and aliquots were periodically withdrawn and analyzed via HPLC to determine the quantity of active released. Particles treated with TMXDI showed significant reductions in the amount of active initially released compared to coatings containing untreated particles.

1. A coating for a seed consisting of:
a. about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone, and polysaccharide;
b. about 0.005 to about 50% by weight of an insecticidally effective amount of an insecticide selected from the group consisting of terbufos, chlorpyrifos, fipronil, chlorethoxyfos, tefluthrin, carbofuran, imidacloprid, tebupirimfos, methoprene and hydroprene;
c. about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof; and
d. optionally water, wherein the binder forms a matrix for the insecticide on the seed.

2. The coating of claim 1 wherein the coating is in contact with a seed selected from the group consisting of soybean, sugarbeet, sunflower, alfalfa, sorghum, rapeseed and tobacco.

3. The coating of claim 1 wherein the binder is a vinyl acetate-ethylene copolymer or polymer or copolymer of vinylidene chloride.

4. An insecticidal coating for a seed consisting of a binder in an amount from about 0.01 to about 15% of the weight of the seed wherein said binder is a vinyl acetate-ethylene copolymer or polymer or copolymer of vinylidene chloride and an insecticidally effective amount of an insecticide selected from the group consisting of imidicloprid, chlorpyrifos, fipronil, tefluthrin and tebupirimfos and in the range from about 0.005 to about 50% of the weight of the seed, and about 0.01% to about 20% by weight of a film overcoat selected from the group consisting of methyl cellulose, hydroxypropylmethylcellulose, polyvinyl acetate and polethylene glycol, wherein said binder forms a matrix for the insecticide on the seed.

5. A method of controlling insect pests from damaging a crop plant comprising applying to a seed an insecticidal coating according to claim 1.

6. A method of controlling insect pests from damaging a crop plant comprising applying to a seed an insecticidal coating according to claim 4.

7. A method of protecting emerging seedlings of a crop plant from one or more insect organisms in the seed growing soil environment which comprises applying to the seeds of the crop plant an insecticidally effective amount of a coating according to claim 1.

8. An insecticidal coating for a seed consisting of:
a. about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone and polysaccharide;
b. about 0.005 to about 50% by weight of an insecticidally effective amount of an insecticide selected from the group consisting of terbufos, chlorpyrifos, fipronil, chlorethoxyfos, tefluthrin, carbofuran, imidacloprid, tebupirimfos, methoprene and hydroprene;
c. about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof; and
d. optionally, water, one or more fungicides or herbicides, or both, a filler selected from the group consisting of wood flours, clays, inorganic solids, activated carbon, diatomaceous earth and calcium carbonate, and mixtures thereof, a plasticizer, a bird repellent compound, a safener, a fertilizer, a biocontrol agent, a colorant, a brightener, a surface active agent and a seed primer, wherein the binder forms a matrix for the insecticide on the seed.

9. A method of controlling insect pests from damaging a crop plant comprising applying to a seed an insecticidal coating according to claim 8.

10. A method of protecting emerging seedlings of a crop plant from one or more insects comprising applying to the seeds of the crop plant an insecticidally effective amount of the coating according to claim 8.

11. A coating for a seed consisting of:
a. about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone, and polysaccharide;
b. about 0.005 to about 50% by weight of an effective amount of an active selected from the group consisting of pesticides, fungicides, herbicides, namaticides, insectides, fertilizers, plant growth regulators, and micronutrients;
c. 0 to about 40% by weight of a particulate material selected from the group consisting of a clay, a treated clay, a silica powder, an attapulgite material, finely ground natural cellulosic materials, and regular or modified starches;
d. about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof; and
e. optionally water.

12. The coating of claim 11 wherein the active is an insecticide selected from the group consisting of terbufos, chlorpyrifos, fipronil, chlorethoxyfos, tefluthrin, carbofuran, imidacloprid, tebupirimfos, methoprene and hydroprene.

13. The seed coating of claim 12 comprising about 0.1 to about 30% by weight of a particulate material selected from the group consisting of a clay, a treated clay, a silica powder, an attapulgite material, finely ground natural cellulosic materials, and regular or modified starches and water.

14. A method of controlling insect pests from damaging a crop plant comprising applying to a seed the coating according to claim 12.

15. A method of protecting emerging seedlings of a crop plant from one or more insects comprising applying to the seeds of the crop plant an insecticidally effective amount of the coating according to claim 12.

16. A method for making a core-shell particle suitable for coating a seed comprising:
a. mixing about 0.005 to about 50% by weight of an active ingredient selected from the group consisting of pesticides, fungicides, herbicides, namaticides, insectides, fertilizers, plant growth regulators, and micronutrients with about 0.01 to about 15% by weight of a crystalline polymer to form an active associated with a polymer matrix;
b. suspending the active associated polymer in a solution of coating material selected from the group consisting of wax, fatty alcohols, fatty acids, water-dispersible polymers, and silicones;
c. changing the chemical characteristics of the solution of step b to precipitate the coating material onto the active associated polymer to form core-shell active particles; and
d. filtering the solution to recover the core-shell active particles.

17. A method for making a core-shell active particle suitable for coating a seed comprising:
a. mixing about 0.005 to about 50% by weight of an active ingredient selected from the group consisting of pesticides, fungicides, herbicides, namaticides, insectides, fertilizers, plant growth regulators, and micronutrients with about 0 to about 35% by weight of particulate material selected from the group consisting of a clay, a treated clay, a silica powder, an attapulgite material, finely ground natural cellulosic materials, and regular or modified starches to allow the active to penetrate the surface of the particulate material;
b. adding about 0.01 to about 15% by weight of one or more binders selected from the group consisting of polymers and copolymers of polyvinyl acetate, methyl cellulose, polyvinyl alcohol, vinylidene chloride, acrylic, cellulose, polyvinylpyrrolidone, and polysaccharide;
c. mixing the active, particulate material, and binder above the melting point of the binder;
d. cooling the active, particulate material, and binder mixture to form a solid;
e. grinding the mixture into a fine particulate active particle; and
f. mixing the active particle with about 0.01% to about 20% by weight of a film overcoat selected from the group consisting of methyl cellulose, hydroxypropylmethylcellulose, dextrin, gums, waxes, vegetable or paraffin oils, water soluble or water dispersible polysaccharides and their derivatives, alginates, starch, cellulose, synthetic polymers, polyethylene oxide, polyvinyl alcohol, polyvinylpyrrolidone, polyvinyl acetate, polyethylene glycol and polymers and copolymers and mixtures thereof.

18. The method of claim 17 wherein the core-shell active particle is less than 150 microns.

19. A method for making a cross-linked active particle suitable for coating a seed comprising:
a. mixing an active particle suspended in an aqueous solution with a cross-linking additive selected from the group consisting of metaphenylene diisocyanate (polyphenylene diisocyanate—“PAPI”), toluene diisocyanate (“TDI”), tetramethylxylene diisocyanate (TMXDI), hexamethylene diisocyanate (“HDI”) or its active biuret (Desmodur N), trialkoxy-silanepropylisocyanate, trimethoxy- end terminated siloxanes, and triethoxy- end terminated siloxanes;
b. optionally mixing a catalyst in the aqueous solution; and
c. filtering to recover the cross-linked active particle.
